(19) United States
(12) Patent Application Publication
(10) Pub. No.: US 2026/0352370 A1
(43) Pub. Date: Nov. 5, 2026

(54) CYCLIC REDUNDANCY CHECK FOR DOWNLINK CONTROL INFORMATION

(71) Applicant: QUALCOMM Incorporated, San Diego, CA (US)

(72) Inventors: Lior UZIEL, Hod Hasharon (IL); Peer BERGER, Hod Hasharon (IL); Tal OVED, Modiin (IL)

(21) Appl. No.: 19/197,431

(22) Filed: May 2, 2025

(51) Int. Cl. H04L 1/00; H04W 72/232

(52) U.S. Cl. CPC H04L 1/0061; H04W 72/232

(57) ABSTRACT

Various aspects of the present disclosure generally relate to wireless communication. In some aspects, a user equipment (UE) may receive, from a network node, a message that includes an indication of a location of a physical downlink control channel (PDCCH) message. The UE may receive, from the network node, the PDCCH message in the location, wherein a quantity of cyclic redundancy check (CRC) bits associated with the PDCCH message is in accordance with the indication of the location of the PDCCH message. In some aspects, the quantity of CRC bits may be reduced relative to a quantity of CRC bits configured for blind decoded PDCCH messages. Numerous other aspects are described.

### FIELD OF THE DISCLOSURE

Aspects of the present disclosure generally relate to wireless communication and specifically relate to techniques, apparatuses, and methods associated with a cyclic redundancy check for downlink control information.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some cases, to receive control signaling, such as downlink control information, a user equipment (UE) may perform blind decoding on a physical downlink control channel. For example, in blind decoding, the UE may detect multiple possible valid decoding outputs and may check cyclic redundancy check bits to determine which, if any, output of the possible decoding outputs is correct or intended for reception by the UE.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a network node, a message that includes an indication of a location of a physical downlink control channel (PDCCH) message. The processing system may be configured to cause the UE to receive, from the network node, the PDCCH message in the location, wherein a quantity of cyclic redundancy check (CRC) bits associated with the PDCCH message is in accordance with the indication of the location of the PDCCH message.

Some aspects described herein relate to a network node. The network node may include a processing system. The processing system may include one or more processors and one or more code-storing memories coupled with the one or more processors. The processing system may be configured to cause the network node to transmit, to a UE, a message that includes an indication of a location of a PDCCH message. The processing system may be configured to cause the network node to transmit, to the UE, the PDCCH message in the location, wherein a quantity of CRC bits associated with the PDCCH message is in accordance with the indication of the location of the PDCCH message.

Some aspects described herein relate to a method of wireless communication performed by a UE. The method may include receiving, from a network node, a message that includes an indication of a location of a PDCCH message. The method may include receiving, from the network node, the PDCCH message in the location, wherein a quantity of CRC bits associated with the PDCCH message is in accordance with the indication of the location of the PDCCH message.

Some aspects described herein relate to a method of wireless communication performed by a network node. The method may include transmitting, to a UE, a message that includes an indication of a location of a PDCCH message. The method may include transmitting, to the UE, the PDCCH message in the location, wherein a quantity of CRC bits associated with the PDCCH message is in accordance with the indication of the location of the PDCCH message.

Some aspects described herein relate to a non-transitory computer-readable medium that stores a set of instructions for wireless communication by a UE. The set of instructions, when executed by one or more processors of the UE, may cause the UE to receive, from a network node, a message that includes an indication of a location of a PDCCH message. The set of instructions, when executed by one or more processors of the UE, may cause the UE to receive, from the network node, the PDCCH message in the location, wherein a quantity of CRC bits associated with the PDCCH message is in accordance with the indication of the location of the PDCCH message.

Some aspects described herein relate to a non-transitory computer-readable medium that stores a set of instructions for wireless communication by a network node. The set of instructions, when executed by one or more processors of the network node, may cause the network node to transmit, to a UE, a message that includes an indication of a location of a PDCCH message. The set of instructions, when executed by one or more processors of the network node, may cause the network node to transmit, to the UE, the PDCCH message in the location, wherein a quantity of CRC bits associated with the PDCCH message is in accordance with the indication of the location of the PDCCH message.

Some aspects described herein relate to an apparatus for wireless communication. The apparatus may include means for receiving, from a network node, a message that includes an indication of a location of a PDCCH message. The apparatus may include means for receiving, from the network node, the PDCCH message in the location, wherein a quantity of CRC bits associated with the PDCCH message is in accordance with the indication of the location of the PDCCH message.

Some aspects described herein relate to an apparatus for wireless communication. The apparatus may include means for transmitting, to a UE, a message that includes an indication of a location of a PDCCH message. The apparatus may include means for transmitting, to the UE, the PDCCH message in the location, wherein a quantity of CRC bits associated with the PDCCH message is in accordance with the indication of the location of the PDCCH message.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example resource structure for wireless communication.

FIG. 3 is a diagram of an example associated with cyclic redundancy check (CRC) size reduction for non-blind decoded downlink control information (DCI).

FIG. 4 is a diagram of an example associated with CRC for non-blind decoded DCI.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIG. 7 is a diagram of an example apparatus for wireless communication.

FIG. 8 is a diagram of an example apparatus for wireless communication.

### DETAILED DESCRIPTION

In some examples, a control resource set (CORESET) may be configured for one or more slots, and the CORESET may include resources (e.g., time and frequency resources) that may be structured to support an efficient use of resources for one or more physical downlink control channels (PDCCHs). For instance, a network node may transmit a PDCCH message via one or more PDCCH candidates within the CORESET. In some examples, the PDCCH message may include downlink control information (DCI) that may schedule one or more physical downlink shared channel (PDSCH) messages for a user equipment (UE). In some examples, the CORESET may include one or more control channel elements (CCEs) that span a portion of the system bandwidth. A CCE may include DCI that is used to provide control information for wireless communication. In some examples, the network node may transmit DCI during multiple CCEs, and the quantity of CCEs used for transmission of DCI may represent an aggregation level (AL) used by the network node for the transmission of DCI.

In some cases, to receive control signaling, such as DCI, the UE may perform blind decoding on a PDCCH. For instance, in blind decoding, the UE may detect multiple possible valid decoding outputs and may check cyclic redundancy check (CRC) bits to determine which, if any, output of the possible decoding outputs is correct or intended for reception by the UE. In some examples, the UE may be unaware of whether decoded control signaling is intended for reception by the UE before the UE checks the CRC bits. Accordingly, CRC decoding may be used to reduce the likelihood of false alarms, where the UE decodes DCI not intended for the UE, interprets noise or other signals as DCI, or wrongly interprets a DCI intended for the UE (e.g., when a polar decoder issues a list of several decoded options with decoding “grades”, the best “graded” option that passes the CRC is selected).

In some examples, the UE may be configured to receive DCI in accordance with non-blind decoding techniques. For instance, the network node may transmit an indication, to the UE, of a location (e.g., a PDCCH candidate) or other information for reception of the DCI, which may be referred to as an “unveiling” of the DCI. In some cases, the network node may indicate one or more specific PDCCH candidates where the DCI will be transmitted, a fallback format or non-fallback format (e.g., a DCI format 1_x or a DCI format x_0) for the DCI, or a radio network temporary identifier (RNTI) corresponding to the DCI. Accordingly, as the network node may indicate the location of the DCI or other information for reception of the DCI, non-blind decoding techniques may reduce the quantity of PDCCH candidates that the UE needs to search or decode and the processing performed by the UE when receiving DCI, thereby decreasing processing overhead and power consumption for the UE. Additionally, non-blind decoding techniques may reduce the likelihood of false alarms relative to blind decoding techniques.

In some cases, however, techniques used for reduction of false alarms for blind decoded DCI may be redundant for non-blind decoded DCI. For instance, a quantity of CRC bits configured for DCI may be based on a likelihood of false alarms or may be configured such as to achieve a target false alarm likelihood. In some wireless communications systems, a CRC size of 24 bits may be used, which may correspond to a false alarm likelihood of 2⁻²⁴. However, the unveiling of information associated with the DCI, such as the location (e.g., PDCCH candidate), the fallback format, or the RNTI, may reduce decoding operations and thereby reduce the likelihood of false alarms for non-blind decoded DCI. Accordingly, because non-blind decoded DCI is associated with lower likelihood of false alarms relative to blind decoded DCI, using the same quantity of CRC bits for non-blind decoded DCI and blind decoded DCI may be inefficient, and the UE may perform more processing than may be needed for achieving the target false alarm likelihood. For instance, as the UE may perform a reduced quantity of searches when using non-blind decoded DCI, a quantity of DCI may be reduced for non-blind decoded DCI relative to blind decoded DCI while achieving a same error probability.

Various aspects relate generally to CRC for non-blind decoded DCI. Some aspects more specifically relate to the configuration of a reduced quantity of CRC bits for non-blind decoded DCI relative to blind decoded DCI. In some aspects, a UE may receive a message including an indication of a location of a PDCCH message (e.g., an unveiling of the PDCCH message) from a network node. The UE may receive the PDCCH message using the reduced quantity of CRC bits. In some aspects, the reduced quantity of CRC bits may be derived from a probability of false detection of a PDCCH on a certain time window (e.g., as determined by the network node). In some cases, the probability of false detection of a timeframe depends on the probability of false detection of a single PDCCH and a quantity of the allocations that are searched in that time window. In some aspects, the network node may transmit an indication of the quantity of allocations of the PDCCHs transmitted to a UE, thereby reducing the quantity of searches performed by the UE. In some aspects, when the UE receives the message indicating the location of the PDCCH message, the UE may (e.g., implicitly, based on receiving the message) perform decoding for the PDCCH message using the reduced quantity of CRC bits. Additionally, or alternatively, the UE may receive a message, from the network node, that configures the reduced quantity of CRC bits. In some aspects, a DCI payload size may be increased in accordance with the reduction of the CRC bits, which may allow for an increase in a data rate for the DCI while maintaining a same code rate relative to blind decoded DCI. In some other aspects, the DCI payload size may be the same as for blind decoded DCI, which may achieve a reduced code rate. In additional aspects, the CRC bits can be reduced while also reducing a total coded word size for the DCI, which may lead to an increase in spectral efficiency. In some aspects, the UE may be configured to use different CRC polynomials for CRC operations in accordance with the quantity of CRC bits. For instance, the UE may be configured (e.g., by the network node) with multiple CRC polynomials, and each CRC polynomial may correspond to one or more quantities of CRC bits. Additionally, or alternatively, the network node may indicate a timeline associated with an activation of the reduction in CRC size, which may be relative to reception of the message indicating the location of the DCI.

Particular aspects of the subject matter described in this disclosure can be implemented to realize one or more of the following potential advantages. In some aspects, by reducing the quantity of CRC bits, the described techniques may reduce the processing overhead and power consumption associated with DCI decoding for the UE. Additionally, the described techniques may allow for increasing the data rate through the addition of payload bits, and allow the wireless communication system to support larger DCI sizes without increasing the resource allocation for PDCCH. Accordingly, the DCI may be more suited for scenarios involving single DCI scheduling of multiple physical channels. Additionally, or alternatively, the described techniques may be used to reduce the code rate associated with DCI by maintaining the same payload size and coded word size, thereby improving reception performance and reducing the block error rate (BLER) relative to blind decoded DCI. In some aspects, the described techniques may support increasing spectral efficiency by reducing the coded word size and resource allocation, thereby reducing a blocking probability associated with the DCI and improving the utilization of PDCCH resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (For instance, cellular vehicle-to-everything (CV2X) communication), frequency spectrum expansion, overlapping spectrum use, small cell deployments, non-terrestrial network (NTN) deployments, device aggregation, advanced duplex communication (For instance, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

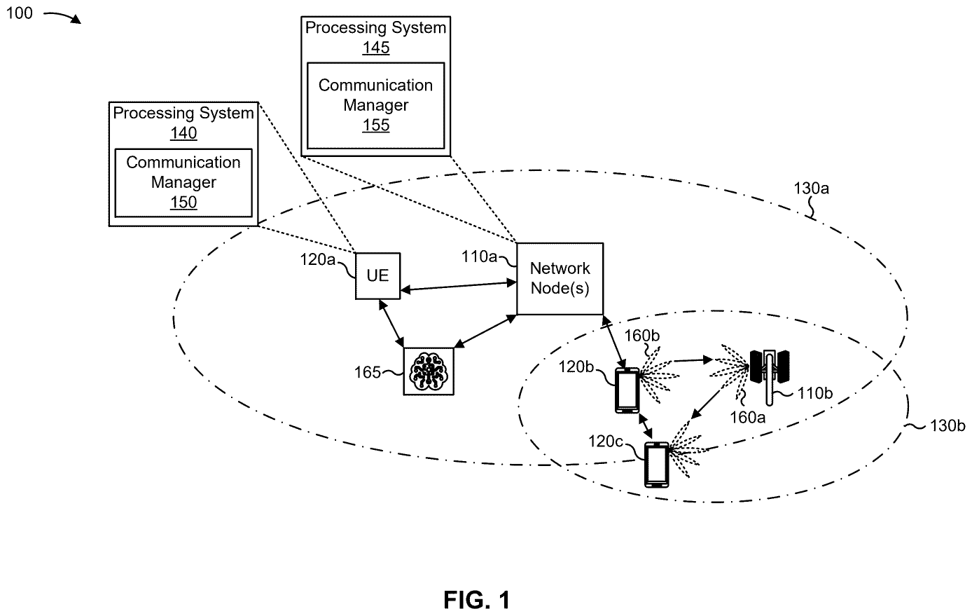

FIG. 1 is a diagram illustrating an example of a wireless communication network 100. The wireless communication network 100 may be or may include elements of a 5G network or a 6G network, among other examples. The wireless communication network 100 may include multiple network nodes 110. For instance, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For instance, in FIG. 1, the network nodes 110 support communication with a UE 120a, a UE 120b, and a UE 120c (each of which also may be referred to herein simply as a “UE 120”). In some cases, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some cases, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For instance, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (For instance, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (For instance, operatively coupled, communicatively coupled, electronically coupled, or electrically coupled) with one or more of the processors. One or more of the memories may individually or collectively store processor-executable code or instructions (such as software) (For instance, which may be referred to as “one or more code-storing memories” or “code-storing memory circuitry”). For instance, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, In some cases, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (For instance, a 5G or 6G compliant) modem). In some cases, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some cases, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (For instance, a single physical structure) or may be implemented as two or more physical nodes (For instance, two or more distinct physical structures). For instance, a network node 110 may be a device or system that implements a part of a radio protocol stack, a device or system that implements a full radio protocol stack (such as a full gNB protocol stack), or a collection of devices or systems that collectively implement the full radio protocol stack. For instance, and as shown, a network node 110 may be an aggregated network node having an aggregated architecture, meaning that the network node 110 may implement a full radio protocol stack that is physically and logically integrated within a single physical structure in the wireless communication network 100. For instance, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (For instance, via a backhaul link) or indirectly (For instance, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some cases, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some cases, a single network node 110 may include a combination of one or more CUs, one or more DUs, or one or more RUs. In some cases, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (For instance, an open cloud (O-Cloud) platform). An SMO framework may support RAN deployment and provisioning of non-virtualized and virtualized network elements.

In some cases, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (For instance, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (For instance, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (For instance, a smart watch, smart clothing, smart glasses, a smart wristband, or smart jewelry), a gaming device, an entertainment device (For instance, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (For instance, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some cases, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (For instance, frames, subframes, slots, and symbols), frequency domain resources (For instance, frequency bands, component carriers (CCs), subcarriers, resource blocks, and resource elements), and spatial domain resources (For instance, particular transmit directions or beams).

Frequency domain resources may be subdivided into bandwidth parts (BWPs). A BWP may be a block of frequency domain resources (For instance, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (For instance, by a network node 110 transmitting a DCI configuration to the one or more UEs 120) or reconfigured (For instance, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For instance, downlink reference signals include a primary synchronization signal (PSS), a secondary SS (SSS), an SS block (SSB) (For instance, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (For instance, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For instance, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For instance, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (For instance, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For instance, a PUCCH can carry UCI, while a PUSCH can carry a MAC-CE, an RRC message, or user data, among other examples. UCI can include a scheduling request (SR), HARQ feedback information (For instance, a HARQ acknowledgement (ACK) indication or a HARQ negative acknowledgement (NACK) indication), uplink power control information (For instance, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (For instance, indicative of a beam used to transmit a CSI-RS), an SS/PBCH resource block indicator (SSBRI) (For instance, indicative of a beam used to transmit an SSB), a layer indicator (LI), a rank indicator (RI), or measurement information (For instance, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (For instance, data, control information, or reference signal information) transmitted by a network node 110 to a UE 120, or vice versa, may be represented as a sequence of binary bits that are mapped (For instance, modulated) to an analog signal waveform (For instance, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some cases, the network node 110 or the UE 120 (For instance, using the processing system 145 or the processing system 140, respectively) may select an MCS (For instance, an order of quadrature amplitude modulation (QAM), such as 64-QAM, 128-QAM, or 256-QAM, among other examples) for a downlink signal or an uplink signal. For instance, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some cases, the network node 110 or the UE 120 (For instance, using the processing system 145 or the processing system 140, respectively, or one or more coupled encoders or modems) may perform a channel coding operation or a forward error correction (FEC) operation to control errors in transmitted information. For instance, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (For instance, using the processing system 145 or one or more modems) may further perform spatial processing (For instance, precoding) on the encoded information to generate one or more processed or precoded signals for downlink or uplink transmission, respectively. In some cases, the network node 110a or the UE 120a may perform codebook-based precoding or non-codebook-based precoding. Codebook-based precoding may involve selecting a precoder (For instance, a precoding matrix) using a codebook. For instance, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (For instance, using the processing system 145 or the processing system 140, respectively, or one or more coupled modems) may perform signal processing (For instance, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (For instance, received information) that estimates the information transmitted by the network node 110 or the UE 120 via the downlink or uplink signals. The network node 110a or the UE 120a (For instance, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some cases, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For instance, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (For instance, an angle of arrival, a horizontal direction, or a vertical direction), or a set of parameters or resources associated with one or more aspects of a directional signal, among other examples.

In some cases, a network node 110 or a UE 120 may implement massive MIMO, which may be associated with an increased (For instance, “massive”) quantity of antennas at the network node 110 or at the UE 120, such as in a network implementing mmWave technology, which enables more precise beamforming or reduced interference. In some cases, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For instance, an initial beam acquisition operation may involve the network node 110 transmitting signals (For instance, SSBs or other signals) via respective beams (For instance, of the beams 160 of the network node 110) and the UE 120 receiving and measuring the signal(s) via respective beams of multiple beams (For instance, from the beams 160 of the UE 120) to identify a best beam (or beam pair) for communication between the UE 120 and the network node 110. A beam refinement operation may involve a first device (For instance, the UE 120 or the network node 110) transmitting signal(s) via a subset of beams (For instance, identified based on, or otherwise associated with, measurements reported as part of one or more other beam management operations). A second device (For instance, the network node 110 or the UE 120) may receive the signal(s) via a single beam (For instance, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (For instance, referred to herein as an “AI/ML model”), such as a program that includes a machine learning (ML) model or an artificial neural network (ANN) model. The AI/ML model may be deployed at one or more devices 165 (For instance, one or more network nodes 110, one or more UEs 120, one or more servers, or one or more components of a cloud computing network, among other examples). For instance, in a deployment in which AI/ML functionality is performed independently at a device 165, sometimes referred to as “overlay AI/ML,” the AI/ML model (or an instance or portion of the AI/ML model) may be deployed at a UE 120 (For instance, by the processing system 140), a network node 110 (For instance, by the processing system 145), one or more servers, or one or more components of a cloud computing network, among other examples. Additionally, or alternatively, in a deployment where AI/ML functionality is coordinated between different devices 165, sometimes referred to as “coordinated AJIML,” or performed at all device and network layers, sometimes referred to as “native AJIML,” the AI/MVL model (or an instance of the AI/ML model) may be deployed at multiple devices 165 (For instance, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (For instance, to increase privacy, reliability, or efficient use of network bandwidth, or to reduce latency, among other examples). For instance, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, In some cases, the AI/ML model(s) may enable AI-as-a-Service (For instance, an end-to-end AI/ML service via a user plane) for use cases, such as a self-organizing network (SON), minimization of drive test (MDT), quality of experience (QoE), positioning, sensing, predictive mobility, or traffic prediction, among other examples. In some cases, AI-as-a-Service use cases may include measurement collection reporting by a UE 120, device selection criteria (For instance, according to a geographical area where measurements are to be collected or UE capabilities to be used to collected measurements), or reporting configurations (For instance, reporting parameters such as location, time, or sensor information, among other examples). Additionally, or alternatively, the AI/ML model(s) may enable AI/ML procedures (For instance, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive, from a network node, a message that includes an indication of a location of a PDCCH message; and receive, from the network node, the PDCCH message in the location, wherein a quantity of CRC bits associated with the PDCCH message is in accordance with the indication of the location of the PDCCH message. Additionally, or alternatively, the communication manager 150 may perform one or more other operations described herein.

In some aspects, the network node 110 may include a communication manager 155. As described in more detail elsewhere herein, the communication manager 155 may transmit, to a UE, a message that includes an indication of a location of a PDCCH message; and transmit, to the UE, the PDCCH message in the location, wherein a quantity of CRC bits associated with the PDCCH message is in accordance with the indication of the location of the PDCCH message. Additionally, or alternatively, the communication manager 155 may perform one or more other operations described herein.

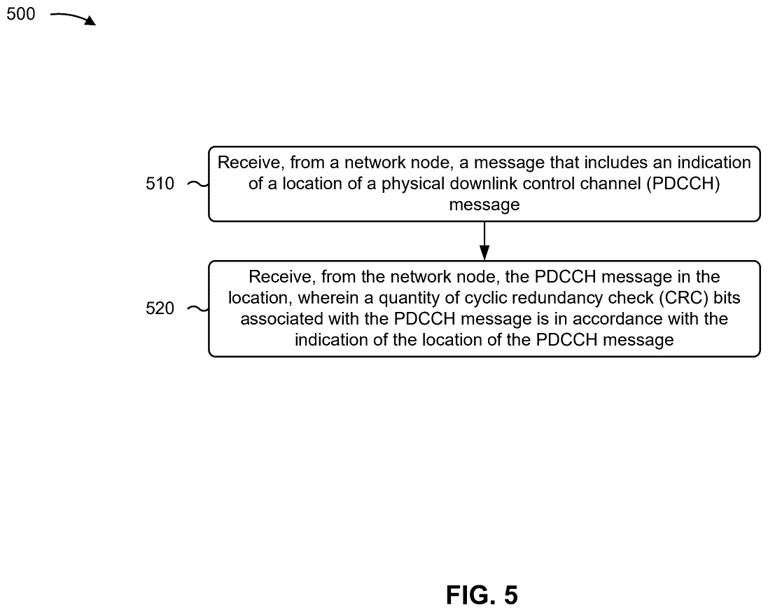

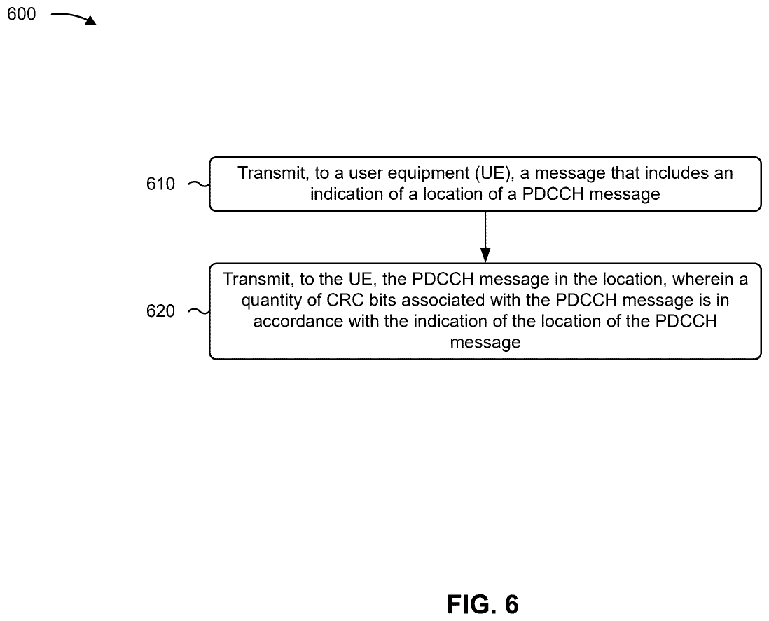

The network node 110, the processing system 145 of the network node 110, the UE 120, the processing system 140 of the UE 120, or any other component(s) of FIG. 1 may implement one or more techniques or perform one or more operations associated with CRC for non-blind decoded DCI, as described in more detail elsewhere herein. For instance, the processing system 145 of the network node 110, or the processing system 140 of the UE 120 may perform or direct operations of, For instance, process 500 of FIG. 5, process 600 of FIG. 6, or other processes as described herein (alone or in conjunction with one or more other processors). Memory of the network node 110 may store data and program code (or instructions) for the network node 110. In some cases, the memory of the network node 110 may store data relating to a UE 120, such as RRC state information or a UE context. Memory of a UE 120 may store data and program code (or instructions) for the UE 120, such as context information. In some cases, the memory of the UE 120 or the memory of the network node 110 may include a non-transitory computer-readable medium storing a set of instructions for wireless communication. For instance, the set of instructions, when executed by one or more processors (For instance, of the processing system 145 or the processing system 140) of the network node 110, or the UE 120, may cause the one or more processors to perform process 500 of FIG. 5, process 600 of FIG. 6, or other processes as described herein. In some cases, executing instructions may include running the instructions, converting the instructions, compiling the instructions, or interpreting the instructions, among other examples.

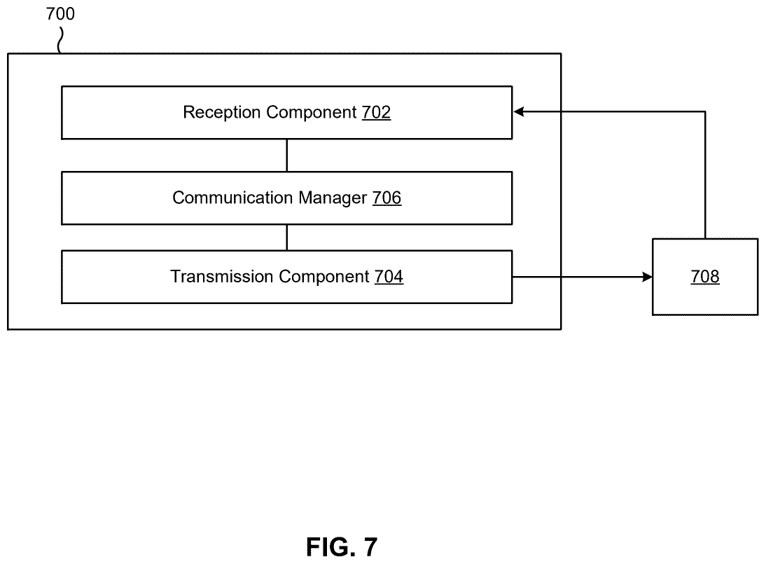

In some aspects, a UE (e.g., the UE 120) includes means for receiving, from a network node, a message that includes an indication of a location of a PDCCH message; or means for receiving, from the network node, the PDCCH message in the location, wherein a quantity of CRC bits associated with the PDCCH message is in accordance with the indication of the location of the PDCCH message. The means for the UE to perform operations described herein may include, For instance, one or more of communication manager 150, processing system 140, a radio, one or more RF chains, one or more transceivers, one or more antennas, one or more modems, a reception component (For instance, reception component 702 depicted and described in connection with FIG. 7), or a transmission component (For instance, transmission component 704 depicted and described in connection with FIG. 7), among other examples.

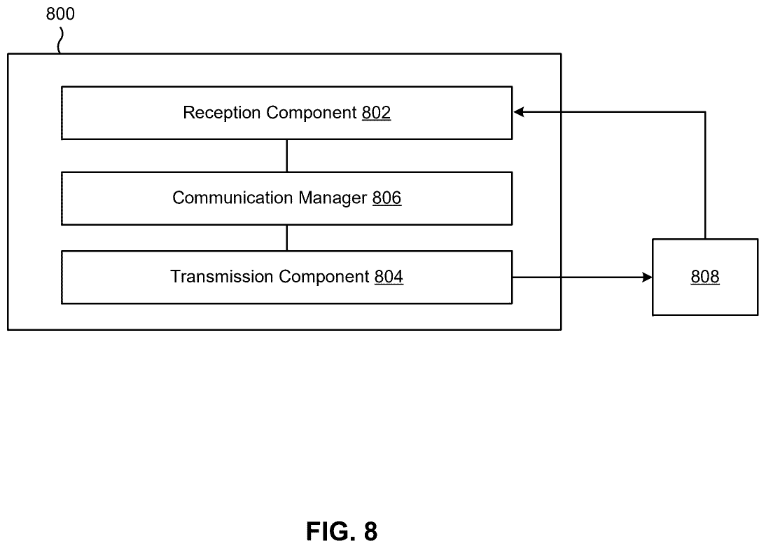

In some aspects, a network node (e.g., the network node 110) includes means for transmitting, to a UE, a message that includes an indication of a location of a PDCCH message; or means for transmitting, to the UE, the PDCCH message in the location, wherein a quantity of CRC bits associated with the PDCCH message is in accordance with the indication of the location of the PDCCH message. The means for the network node to perform operations described herein may include, For instance, one or more of communication manager 155, processing system 145, a radio, one or more RF chains, one or more transceivers, one or more antennas, one or more modems, a reception component (For instance, reception component 802 depicted and described in connection with FIG. 8), or a transmission component (For instance, transmission component 804 depicted and described in connection with FIG. 8), among other examples.

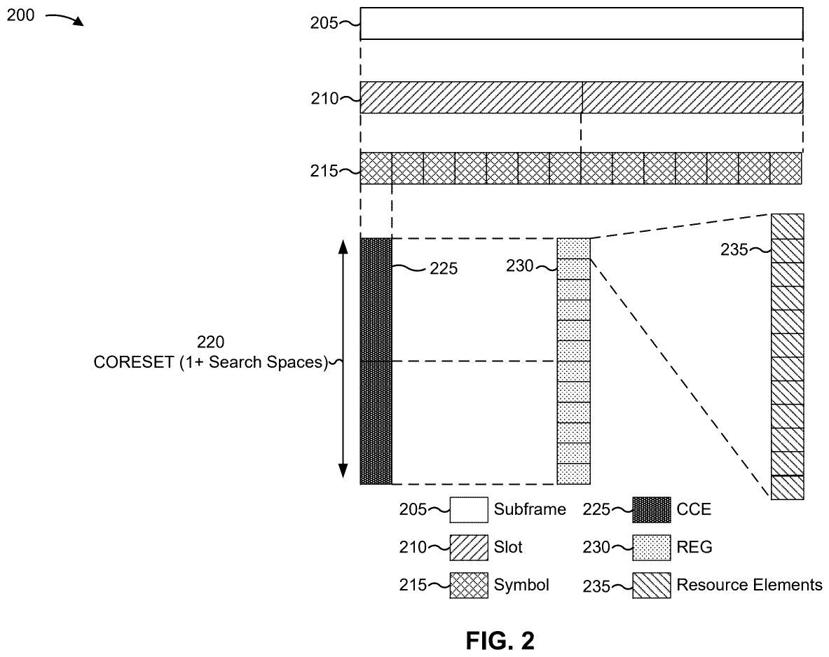

FIG. 2 is a diagram illustrating an example resource structure 200 for wireless communication. Resource structure 200 shows an example of various groups of resources described herein. As shown, resource structure 200 may include a subframe 205. Subframe 205 may include multiple slots 210. While resource structure 200 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes or slots. A slot 210 may include multiple symbols 215, such as 14 symbols per slot.

The potential control region of a slot 210 may be referred to as a CORESET 220 and may be structured to support an efficient use of resources, such as by flexible configuration or reconfiguration of resources of the CORESET 220 for one or more PDCCHs or one or more PDSCHs. In some aspects, the CORESET 220 may occupy the first symbol 215 of a slot 210, the first two symbols 215 of a slot 210, or the first three symbols 215 of a slot 210. Thus, a CORESET 220 may include multiple resource blocks (RBs) in the frequency domain, and either one, two, or three symbols 215 in the time domain. In 5G, a quantity of resources included in the CORESET 220 may be flexibly configured, such as by using RRC signaling to indicate a frequency domain region (e.g., a quantity of resource blocks) or a time domain region (e.g., a quantity of symbols) for the CORESET 220.

As illustrated, a symbol 215 that includes CORESET 220 may include one or more control channel elements (CCEs) 225, shown as two CCEs 225 as an example, that span a portion of the system bandwidth. A CCE 225 may include DCI that is used to provide control information for wireless communication. A network node (e.g., network node 110) may transmit DCI during multiple CCEs 225 (as shown), where the quantity of CCEs 225 used for transmission of DCI represents the AL used by the network node for the transmission of DCI. In FIG. 2, an AL of two is shown as an example, corresponding to two CCEs 225 in a slot 210. In some aspects, different ALs may be used, such as 1, 2, 4, 8, 16, or another AL.

Each CCE 225 may include a fixed quantity of resource element groups (REGs) 230, shown as 6 REGs 230, or may include a variable quantity of REGs 230. In some aspects, the quantity of REGs 230 included in a CCE 225 may be specified by a REG bundle size. A REG 230 may include one resource block, which may include 12 resource elements (REs) 235 within a symbol 215. A resource element 235 may occupy one subcarrier in the frequency domain and one OFDM symbol in the time domain.

A search space may include all possible locations (e.g., in time or frequency) where a PDCCH may be located. A CORESET 220 may include one or more search spaces, such as a UE-specific search space, a group-common search space, or a common search space. A possible location (e.g., in time or frequency) for a PDCCH may be referred to as a PDCCH candidate, and the set of all possible PDCCH locations at an AL may be referred to as a search space. For instance, a search space may include a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) or an AL being used. For instance, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across ALs may be referred to as a search space set.

A CORESET 220 may be interleaved or non-interleaved. An interleaved CORESET 220 may have a CCE-to-REG mapping such that adjacent CCEs are mapped to scattered REG bundles in the frequency domain (e.g., adjacent CCEs are not mapped to consecutive REG bundles of the CORESET 220). A non-interleaved CORESET 220 may have a CCE-to-REG mapping such that all CCEs are mapped to consecutive REG bundles (e.g., in the frequency domain) of the CORESET 220.

In some aspects, a UE 120 may be configured with a reduced quantity of CRC bits for non-blind decoded DCI relative to blind decoded DCI. In some aspects, a UE 120 may receive a message that indicates a location (e.g., a PDCCH candidate) where a PDCCH message carrying DCI is to be transmitted by a network node 110, which may be referred to as an unveiling of the PDCCH message. In some cases, the UE 120 may perform decoding in accordance with a quantity of PDCCH candidates where a PDCCH message may be transmitted. In some aspects, the network node 110 may transmit an indication to the UE 120 of one or more PDCCH candidates where the PDCCH message will be transmitted, thereby reducing the searches performed by the UE 120 to only the indicated PDCCH candidates (e.g., reducing the searches from 44 PDCCH candidates in blind decoding to much fewer PDCCH candidates, such as one, two or three). The indication of the one or more PDCCH candidates may be the message indicating the location of the PDCCH message (e.g., the unveiling message). The UE 120 may receive the PDCCH message using the reduced quantity of CRC bits. For instance, when the UE 120 receives the message indicating the location of the PDCCH message, the UE 120 may (e.g., implicitly based on receiving the message) perform decoding for the PDCCH message using the reduced quantity of CRC bits. Additionally, or alternatively, the UE 120 may receive a message, from the network node 110, that configures the reduced quantity of CRC bits. In some aspects, a DCI payload size may be increased in accordance with the reduction of the CRC bits, which may allow for an increase in a data rate for the DCI while maintaining a same code rate relative to blind decoded DCI. In some other aspects, the DCI payload size may be the same as blind decoded DCI, which may achieve a reduced code rate. In additional aspects, the CRC bits can be reduced while also reducing a total coded word size for the DCI, which may lead to an increase in spectral efficiency. In some aspects, the UE 120 may be configured to use different CRC polynomials for CRC operations in accordance with the quantity of CRC bits. For instance, the UE 120 may be configured (e.g., by the network node 110) with multiple CRC polynomials, and each CRC polynomial may correspond to one or more quantities of CRC bits. Additionally, or alternatively, the network node 110 may indicate a timeline associated with an activation of the reduction in CRC size, which may be relative to reception of the message indicating the location of the DCI.

As indicated above, FIG. 2 is provided as an example. Other examples may differ from what is described with respect to FIG. 2.

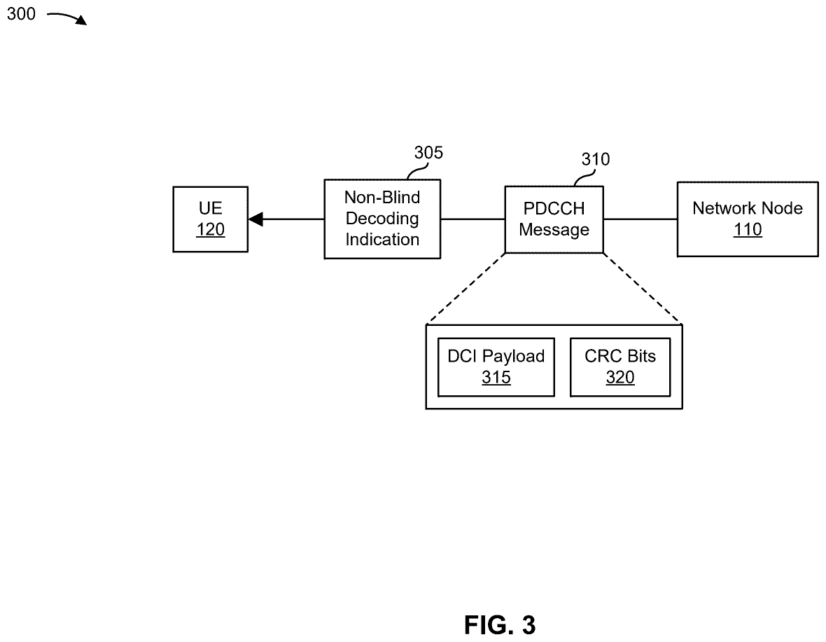

FIG. 3 is a diagram of an example 300 associated with CRC size reduction for non-blind decoded DCI. As shown in FIG. 3, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 3.

In some aspects, the network node 110 may transmit, to the UE 120, a message 305 that indicates a non-blind decoding PDCCH message 310. For instance, the message 305 may indicate a location of the PDCCH message 310, which may include indicating one or more PDCCH candidates where the PDCCH message 310 is to be transmitted, thereby reducing a quantity of PDCCH candidates that the UE 120 is to decode to receive the PDCCH message 310. Additionally, or alternatively, the message 305 may include other information associated with the PDCCH message 310, such as a format (e.g., a DCI format, such as a fallback or non-fallback format), or an RNTI corresponding to the PDCCH message 310.

In some aspects, the network node 110 may transmit, to the UE 120, the PDCCH message 310, which may be referred to as a non-blind decoded PDCCH message 310, in accordance with a reduction of a CRC size of the PDCCH message 310 (e.g., relative to blind decoded PDCCH messages). For instance, the PDCCH message 310 may include a DCI payload 315 and one or more CRC bits 320. In some cases, a blind decoded PDCCH message may be associated with a DCI payload size of K bits and a CRC size of C bits. Additionally, blind decoded PDCCH messages may have a coded word size of E bits, which may correspond to a total quantity of transmitted bits.

In some aspects, the quantity of the CRC bits 320 of the PDCCH message 310 may be reduced by I bits relative to blind decoded PDCCH messages. For instance, the quantity of the CRC bits 320 may be C-I bits. In some aspects, the size of the DCI payload 315 may be increased in accordance with the reduction of the CRC bits 320. For instance, the quantity of bits of the DCI payload 315 of the PDCCH message 310 may be K+I bits. In some cases, a code rate of the PDCCH message 310 may be given by

$$\frac{( K + I ) + ( C - I )}{E} = \frac{K + C}{E} ,$$

which may be the same as a code rate for blind decoded PDCCH messages. Accordingly, the code rate of the PDCCH message 310 may remain the same while increasing the data rate of the PDCCH message 310 relative to blind decoded PDCCH messages, thereby allowing for an increased DCI payload 315 size for a same PDCCH allocation for the PDCCH message 310 relative to blind decoded PDCCH messages. In some cases, a limit (e.g., maximum) DCI size for the PDCCH message 310 may be increased, which may facilitate scheduling multiple data messages (e.g., PDSCH messages or PUSCH messages) via the DCI payload 315.

In some other aspects, the size of the DCI payload 315 may be maintained (e.g., as K bits) relative to the size of the DCI payloads for blind decoded PDCCH messages while reducing the quantity of the CRC bits 320 by I bits. Additionally, the coded word size of the PDCCH message 310 may also remain the same (e.g., as E bits) relative to blind decoded PDCCH messages. Accordingly, the code rate of the PDCCH message 310 may be given by

$$\frac{K + ( C - I )}{E} ,$$

thereby reducing the code rate of the PDCCH message 310 relative to blind decoded PDCCH messages. Reducing the code rate of the PDCCH message 310 while keeping a same size of the DCI payload 315 may result in increased reception performance and a reduced BLER relative to blind decoded PDCCH messages.

In some other aspects, the coded word size of the PDCCH message 310 may be reduced by I bits when reducing the quantity of the CRC bits 320 by I bits relative to blind decoded PDCCH messages, and the size of the DCI payload 315 may be maintained (e.g., as K bits) relative to blind decoded PDCCH messages. In other words, the PDCCH allocation may be reduced for the PDCCH message 310 relative to blind decoded PDCCH messages, and the code rate may be given by

$$\frac{K + ( C - I )}{E - I} .$$

Accordingly, spectral efficiency of the PDCCH may be increased, as PDCCH resource usage is reduced, thereby reducing the probability of blockage and increasing available PDCCH resources. Additionally, or alternatively, the quantity of transmitted bits (e.g., the coded word size) may be dynamically updated (e.g., indicated by the network node 110 to the UE 120), allowing for adjustments to the code rate and the spectral efficiency. Additionally, or alternatively, the coded word size may be based on an AL configured for communications (e.g., PDCCH messages) between the UE 120 and the network node 110.

In some aspects, the reduction in the quantity of the CRC bits 320 (e.g., I) may be selected such that a likelihood (or quantity) of false alarms remains the same as a target likelihood of false alarms (or close to the same, such as satisfying a false alarm threshold) associated with blind decoded PDCCH messages. For instance, the network node 110 (e.g., via a scheduler or traffic manager) may calculate or determine a quantity of decoding operations (e.g., DCI detections) for the UE 120, which may be based on at least one of an activity window, a configured delay, PDCCH repetitions, a quantity of configured HARQ signaling, the transmission of the message 305 unveiling the PDCCH message 310, or other information corresponding to the PDCCH message 310. Accordingly, the network node 110 may obtain the quantity of the CRC bits 320 that may support a same (or close to the same) likelihood of false alarms for the PDCCH message 310 as for blind decoded PDCCH messages. In some cases, such as when an SCS is 15 kilohertz (KHz) and the quantity of CRC bits for blind decoded PDCCH messages is 24 bits, the quantity of reduced CRC bits 320 for the PDCCH message 310, CRC_{R}, may be given by Equation 1 below:

CRC_{R}=24−ceiling(log₂ 44/N) (1)

where N is the quantity of decoding operations (e.g., DCI detections) expected or determined for the UE 120.

In some aspects, the network node 110 may be configured to generate the CRC bits 320 for the PDCCH message 310 in accordance with one or more CRC polynomials. For instance, the network node 110 may be configured to use a same CRC generator polynomial for generating the CRC bits 320 for the PDCCH message 310 and for generating CRC bits for blind decoded PDCCH messages (e.g., g_{CRC24C}), and the network node 110 may use only a subset of the CRC bits generated by the CRC generator polynomial. For instance, the CRC generator polynomial may generate 24 CRC bits, and the network node 110 may use 22 of the 24 CRC bits for the PDCCH message 310 (e.g., an initial 22 of the 24 CRC bits), which may be referred to as a partial usage of the CRC generator polynomial.

Additionally, or alternatively, the network node 110 may be configured to use multiple CRC generator polynomials that may generate different quantities of CRC bits. For instance, the network node 110 may be configured with a set of CRC generator polynomials. In some cases, a first CRC generator polynomial may generate 24 CRC bits, a second CRC generator may generate 22 CRC bits, and a third CRC generator polynomial may generate 20 CRC bits. In some aspects, the network node 110 may select a CRC generator polynomial from the set of CRC generator polynomials in accordance with a quantity of configured or expected decoding operations for the UE 120 (e.g., a value of N). For instance, for UEs 120 with a quantity of decoding operations (e.g., DCI detections) between 1 and 2 (or satisfying one or more first decoding thresholds), the network node 110 may select the third CRC generator polynomial. Additionally, or alternatively, for UEs 120 with a quantity of decoding operations between 3 and 10 (or satisfying one or more second decoding thresholds), the network node 110 may select the second CRC generator polynomial. In some cases, the network node 110 may select the first CRC generator polynomial for other UEs 120 (or UEs 120 satisfying one or more third decoding thresholds). In some aspects, the network node 110 may indicate (e.g., via a message or configuration, or via the message 305) the CRC generator polynomial used for generating the CRC bits 320 or whether partial usage of a CRC generator polynomial is being used by the network node 110.

As indicated above, FIG. 3 is provided as an example. Other examples may differ from what is described with respect to FIG. 3. For instance, K, C, E, and I may be positive integers that may vary in value in different implementations.

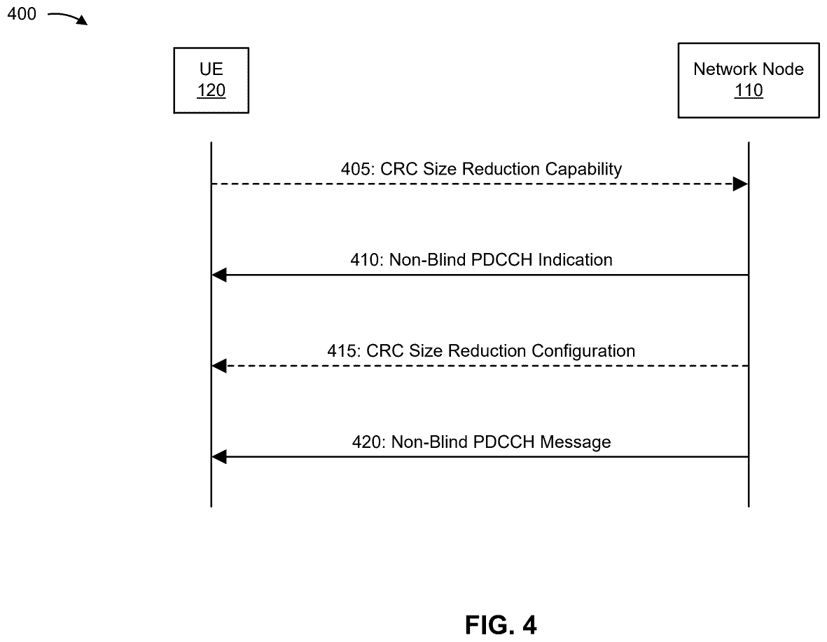

FIG. 4 is a diagram of an example 400 associated with CRC for non-blind decoded DCI. As shown in FIG. 4, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 4.

In some aspects, as shown by reference number 405, the UE 120 may transmit capability information (e.g., via a capability report). In some cases, the capability information may be exchanged as part of a capability negotiation between the UE 120 and the network node 110. For instance, the UE 120 may indicate the capability information (e.g. one or more capabilities of the UE 120) to the network node 110, and the network node 110 may transmit an affirmation message (e.g., to confirm receipt), or the network node 110 may transmit an indication of settings (e.g., a type, flavor, or parameters) that will be used in accordance with the capability information. For instance, the UE 120 may transmit an indication of a capability of the UE 120 associated with supporting a reduction in a quantity of CRC bits (e.g., a CRC size). In some aspects, the capability may indicate that the UE 120 supports receiving non-blind decoded PDCCH messages with a reduced quantity of CRC bits relative to blind decoded PDCCH messages. In some cases, the indication of the settings from the network node 110 as part of the capability negotiation may include an indication of a CRC size reduction, a quantity of possible blind decoding reduction due to a non-blind decoding mode to derive the quantity of CRC bits, or other information as described herein.

In some aspects, as shown by reference number 410, the network node 110 may transmit a message that includes an indication of a location of a PDCCH message (e.g., an unveiling of a non-blind decoded PDCCH message). In some cases, the message may specify resources (e.g., PDCCH candidates, which may be in a CORESET) where the PDCCH message will be transmitted. Additionally, or alternatively, the message may include an indication of a format (e.g., a fallback format) or an identifier (e.g., an RNTI) for the PDCCH message.

In some aspects, as shown by reference number 415, the network node 110 may transmit, to the UE 120, one or more messages that may include configuration information for the UE 120. In some cases, the configuration information may include an indication of the quantity of CRC bits to be used for the PDCCH message. For instance, the one or more messages may indicate a reduced number of CRC bits relative to the number used for blind-decoded PDCCH messages by indicating a bit reduction quantity (e.g., I) or an absolute quantity of CRC bits to be used for the PDCCH message. Additionally, or alternatively, the one or more messages may indicate a polynomial (e.g., a CRC generator polynomial) used by the network node 110 for generation of CRC bits for the PDCCH message, or whether a polynomial (e.g., a polynomial for blind decoded PDCCH messages) is used partially for generating the CRC bits for the PDCCH message. In some cases, the configuration information may additionally, or alternatively, be transmitted as part of a capability negotiation, as described herein.

Additionally, or alternatively, the one or more messages may indicate a timing associated with the activation of the reduced quantity of CRC bits. For instance, the network node 110 may transmit a DCI message or a MAC-CE message that indicates an activation timeline for the reduced quantity of CRC bits, and the activation timeline may be relative to the DCI message, the MAC-CE message, the message indicating the location of the PDCCH message, or another reference point. Accordingly, the timing information may help the UE 120 to synchronize its decoding operations, and may facilitate DCI detection in out-of-sync scenarios.

Additionally, or alternatively, the one or more messages may indicate an RRC configuration (e.g., transmitted via a system information block (SIB), such as SIB1) that may reduce a limit (e.g., maximum) quantity of DCI blind decoding operations for at least some messages. For instance, the limit quantity of DCI blind decoding operations for random access messages (e.g., DCIs for Msg1-4) may be reduced, as a higher likelihood of false alarms may be permitted for such messages. Additionally, or alternatively, the RRC configuration may indicate the reduced quantity of CRC bits for DCI (e.g., for non-blind decoded DCI).

In some aspects, as shown by reference number 420, the network node 110 may transmit the PDCCH message (e.g., the non-blind PDCCH message) to the UE 120 in the indicated location. The PDCCH message may include a DCI payload and CRC bits in accordance with the reduction in the quantity of CRC bits relative to blind decoded DCI, as described herein. The UE 120 may decode the PDCCH message in accordance with the reduced quantity of CRC bits. For instance, the UE 120 may decode the PDCCH message in accordance with a quantity of CRC bits or a polynomial indicated by the network node 110. Additionally, or alternatively, the UE 120 may be configured to decode the PDCCH message in accordance with the reduced quantity of CRC bits based on receiving the message indicating the location of the PDCCH message. In other words, the UE 120 may implicitly determine or calculate the reduction in the quantity of CRC bits in accordance with receiving the message unveiling the PDCCH message (e.g., based on a quantity of decoding operations performed by the UE 120).

Additionally, or alternatively, the UE 120 may (e.g., implicitly) decode the PDCCH message in accordance with a polynomial based on receiving the message indicating the location of the PDCCH message. In some aspects, the UE 120 may (e.g., implicitly) determine an activation timeline for the reduction in the quantity of CRC bits. For instance, the UE 120 may be configured with a delay associated with the activation of the reduction in the quantity of CRC bits. In some cases, when the UE 120 receives the message indicating the unveiling of the PDCCH message, the UE 120 may determine that the quantity of CRC bits is to be reduced after the delay elapses from reception of the message.

In some aspects, the network node 110 may be configured to transmit the PDCCH message in accordance with receiving the indication of the capability of the UE 120. For instance, the network node 110 may be configured to refrain from reducing the quantity of CRC bits for PDCCH messages to UEs 120 that do not indicate support for CRC reduction.

In some aspects, the network node 110 may dynamically adjust the quantity of CRC bits or the polynomial used for CRC generation based on at least one of network conditions, the capability of the UE, or other factors. For instance, the network node 110 may dynamically adjust the quantity of CRC bits to be used for PDCCH messages, and the network node 110 may indicate the adjusted quantity to the UE 120 through one or more subsequent configuration messages.

Accordingly, the described techniques for reducing the quantity of CRC bits in non-blind decoded DCI may reduce processing overhead and power consumption for the UE 120. Additionally, the described techniques may be used to improve spectral efficiency, reduce a code rate, or increase a data rate associated with PDCCH messages. Consequently, the described techniques may support more efficient PDCCH resource utilization and improved reception performance, particularly in scenarios involving single DCI scheduling of multiple physical data channels, relative to using a same CRC size for blind decoded and non-blind decoded PDCCH messages.

As indicated above, FIG. 4 is provided as an example. Other examples may differ from what is described with respect to FIG. 4. For instance, some messages shown in FIG. 4 may be omitted or performed in a different order than shown, or additional messages not shown may be included.

FIG. 5 is a diagram illustrating an example process 500 performed, For instance, at a UE or an apparatus of a UE. Example process 500 is an example where the apparatus or the UE (e.g., UE 120) performs operations associated with CRC for non-blind decoded DCI.

As shown in FIG. 5, in some aspects, process 500 may include receiving, from a network node, a message that includes an indication of a location of a PDCCH message (block 510). For instance, the UE (e.g., using reception component 702 or communication manager 706, depicted in FIG. 7) may receive, from a network node, a message that includes an indication of a location of a PDCCH message, as described above.

As further shown in FIG. 5, in some aspects, process 500 may include receiving, from the network node, the PDCCH message in the location, wherein a quantity of CRC bits associated with the PDCCH message is in accordance with the indication of the location of the PDCCH message (block 520). For instance, the UE (e.g., using reception component 702 or communication manager 706, depicted in FIG. 7) may receive, from the network node, the PDCCH message in the location, wherein a quantity of CRC bits associated with the PDCCH message is in accordance with the indication of the location of the PDCCH message, as described above.

Process 500 may include additional aspects, such as any single aspect or any combination of aspects described below or in connection with one or more other processes described elsewhere herein.

In a first aspect, the quantity of the CRC bits is reduced by a first quantity of bits from an additional quantity of CRC bits configured for blind-decoded PDCCH messages.

In a second aspect, alone or in combination with the first aspect, a first quantity of payload bits associated with the PDCCH message is increased by the first quantity of bits from a second quantity of payload bits configured for the blind-decoded PDCCH messages.

In a third aspect, alone or in combination with one or more of the first and second aspects, a first quantity of payload bits associated with the PDCCH message is the same as a second quantity of payload bits configured for the blind-decoded PDCCH messages, and a first code rate associated with the PDCCH message is reduced from a second rate associated with the blind-decoded PDCCH messages in accordance with the first quantity of payload bits and the quantity of the CRC bits.

In a fourth aspect, alone or in combination with one or more of the first through third aspects, a first coded word size associated with the PDCCH message is reduced by the first quantity of bits from a second coded word size configured for the blind-decoded PDCCH messages, and a first spectral efficiency associated with the PDCCH message is increased from a second spectral efficiency associated with the blind-decoded PDCCH messages in accordance with the first coded word size and the quantity of the CRC bits.

In a fifth aspect, alone or in combination with one or more of the first through fourth aspects, process 500 includes receiving, from the network node, an indication of the quantity of the CRC bits associated with the PDCCH message.

In a sixth aspect, alone or in combination with one or more of the first through fifth aspects, the PDCCH message is received in accordance with the quantity of the CRC bits based at least in part on receiving the message that indicates the location of the PDCCH message.

In a seventh aspect, alone or in combination with one or more of the first through sixth aspects, process 500 includes receiving, from the network node, a message indicating an indication of a timing associated with activation of the quantity of CRC bits.

In an eighth aspect, alone or in combination with one or more of the first through seventh aspects, the PDCCH message is received in accordance with the quantity of the CRC bits based at least in part on a time duration elapsing after reception of the message that includes the location of the PDCCH message.

In a ninth aspect, alone or in combination with one or more of the first through eighth aspects, process 500 includes receiving, from the network node, an indication of a polynomial associated with generation of the CRC bits.

In a tenth aspect, alone or in combination with one or more of the first through ninth aspects, the generation of the CRC bits is performed in accordance with a partial usage of the polynomial, and the polynomial is associated with CRC generation for blind-decoded PDCCH messages.

In an eleventh aspect, alone or in combination with one or more of the first through tenth aspects, the polynomial is different from an additional polynomial associated with CRC generation for blind-decoded PDCCH messages.

In a twelfth aspect, alone or in combination with one or more of the first through eleventh aspects, the polynomial is selected from a plurality of polynomials in accordance with a quantity of decoding operations associated with the PDCCH message.

In a thirteenth aspect, alone or in combination with one or more of the first through twelfth aspects, the quantity of the CRC bits is in accordance with a quantity of decoding operations (e.g., expected decoding operations) associated with the PDCCH message (e.g., with decoding the PDCCH message by the UE).

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, For instance, at a network node or an apparatus of a network node. Example process 600 is an example where the apparatus or the network node (e.g., network node 110) performs operations associated with CRC for non-blind decoded DCI.

As shown in FIG. 6, in some aspects, process 600 may include transmitting, to a UE, a message that includes an indication of a location of a PDCCH message (block 610). For instance, the network node (e.g., using transmission component 804 or communication manager 806, depicted in FIG. 8) may transmit, to a UE, a message that includes an indication of a location of a PDCCH message, as described above.

As further shown in FIG. 6, in some aspects, process 600 may include transmitting, to the UE, the PDCCH message in the location, wherein a quantity of CRC bits associated with the PDCCH message is in accordance with the indication of the location of the PDCCH message (block 620). For instance, the network node (e.g., using transmission component 804 or communication manager 806, depicted in FIG. 8) may transmit, to the UE, the PDCCH message in the location, wherein a quantity of CRC bits associated with the PDCCH message is in accordance with the indication of the location of the PDCCH message, as described above.

Process 600 may include additional aspects, such as any single aspect or any combination of aspects described below or in connection with one or more other processes described elsewhere herein.

In a first aspect, the quantity of the CRC bits is reduced by a first quantity of bits from an additional quantity of CRC bits configured for blind-decoded PDCCH messages.

In a second aspect, alone or in combination with the first aspect, a first quantity of payload bits associated with the PDCCH message is increased by the first quantity of bits from a second quantity of payload bits configured for the blind-decoded PDCCH messages.

In a third aspect, alone or in combination with one or more of the first and second aspects, a first quantity of payload bits associated with the PDCCH message is the same as a second quantity of payload bits configured for the blind-decoded PDCCH messages, and a first code rate associated with the PDCCH message is reduced from a second rate associated with the blind-decoded PDCCH messages in accordance with the first quantity of payload bits and the quantity of the CRC bits.

In a fourth aspect, alone or in combination with one or more of the first through third aspects, a first coded word size associated with the PDCCH message is reduced by the first quantity of bits from a second coded word size configured for the blind-decoded PDCCH messages, and a first spectral efficiency associated with the PDCCH message is increased from a second spectral efficiency associated with the blind-decoded PDCCH messages in accordance with the first coded word size and the quantity of the CRC bits.

In a fifth aspect, alone or in combination with one or more of the first through fourth aspects, process 600 includes transmitting, to the UE, an indication of the quantity of the CRC bits associated with the PDCCH message.

In a sixth aspect, alone or in combination with one or more of the first through fifth aspects, the quantity of the CRC bits is selected in accordance with receiving the indication of the location of the PDCCH message.

In a seventh aspect, alone or in combination with one or more of the first through sixth aspects, process 600 includes transmitting, to the UE, a message indicating an indication of a timing associated with activation of the quantity of CRC bits.

In an eighth aspect, alone or in combination with one or more of the first through seventh aspects, the PDCCH message is received in accordance with the quantity of the CRC bits based at least in part on a time duration elapsing after reception of the message that includes the location of the PDCCH message.

In a ninth aspect, alone or in combination with one or more of the first through eighth aspects, process 600 includes transmitting, to the UE, an indication of a polynomial associated with generation of the CRC bits.

In a tenth aspect, alone or in combination with one or more of the first through ninth aspects, the generation of the CRC bits is performed in accordance with a partial usage of the polynomial, and the polynomial is associated with CRC generation for blind-decoded PDCCH messages.

In an eleventh aspect, alone or in combination with one or more of the first through tenth aspects, the polynomial is different from an additional polynomial associated with CRC generation for blind-decoded PDCCH messages.

In a twelfth aspect, alone or in combination with one or more of the first through eleventh aspects, the polynomial is selected from a plurality of polynomials in accordance with a quantity of decoding operations associated with the PDCCH message.

In a thirteenth aspect, alone or in combination with one or more of the first through twelfth aspects, the quantity of the CRC bits is in accordance with a quantity of decoding operations associated with the PDCCH message.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (For instance, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (For instance, the processing system 140 described in connection with FIG. 1) of the UE.

In some aspects, the apparatus 700 may be configured to perform one or more operations described herein in connection with FIGS. 2-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For instance, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For instance, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The reception component 702 may receive, from a network node, a message that includes an indication of a location of a PDCCH message. The reception component 702 may receive, from the network node, the PDCCH message in the location, wherein a quantity of CRC bits associated with the PDCCH message is in accordance with the indication of the location of the PDCCH message.

The reception component 702 may receive, from the network node, an indication of the quantity of the CRC bits associated with the PDCCH message.

The reception component 702 may receive, from the network node, a message indicating an indication of a timing associated with activation of the quantity of CRC bits.

The reception component 702 may receive, from the network node, an indication of a polynomial associated with generation of the CRC bits.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (For instance, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (For instance, the processing system 145 described in connection with FIG. 1) of the network node.

In some aspects, the apparatus 800 may be configured to perform one or more operations described herein in connection with FIGS. 2-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For instance, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For instance, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The transmission component 804 may transmit, to a UE, a message that includes an indication of a location of a PDCCH message. The transmission component 804 may transmit, to the UE, the PDCCH message in the location, wherein a quantity of CRC bits associated with the PDCCH message is in accordance with the indication of the location of the PDCCH message.

The transmission component 804 may transmit, to the UE, an indication of the quantity of the CRC bits associated with the PDCCH message.

The transmission component 804 may transmit, to the UE, a message indicating an indication of a timing associated with activation of the quantity of CRC bits.

The transmission component 804 may transmit, to the UE, an indication of a polynomial associated with generation of the CRC bits.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: receiving, from a network node, a message that includes an indication of a location of a PDCCH message; and receiving, from the network node, the PDCCH message in the location, wherein a quantity of CRC bits associated with the PDCCH message is in accordance with the indication of the location of the PDCCH message.

Aspect 2: The method of Aspect 1, wherein the quantity of the CRC bits is reduced by a first quantity of bits from an additional quantity of CRC bits configured for blind-decoded PDCCH messages.

Aspect 3: The method of Aspect 2, wherein a first quantity of payload bits associated with the PDCCH message is increased by the first quantity of bits from a second quantity of payload bits configured for the blind-decoded PDCCH messages.

Aspect 4: The method of Aspect 2, wherein a first quantity of payload bits associated with the PDCCH message is the same as a second quantity of payload bits configured for the blind-decoded PDCCH messages, and wherein a first code rate associated with the PDCCH message is reduced from a second rate associated with the blind-decoded PDCCH messages in accordance with the first quantity of payload bits and the quantity of the CRC bits.

Aspect 5: The method of Aspect 2, wherein a first coded word size associated with the PDCCH message is reduced by the first quantity of bits from a second coded word size configured for the blind-decoded PDCCH messages, and wherein a first spectral efficiency associated with the PDCCH message is increased from a second spectral efficiency associated with the blind-decoded PDCCH messages in accordance with the first coded word size and the quantity of the CRC bits.

Aspect 6: The method of any of Aspects 1-5, further comprising: receiving, from the network node, an indication of the quantity of the CRC bits associated with the PDCCH message.

Aspect 7: The method of any of Aspects 1-6, wherein the PDCCH message is received in accordance with the quantity of the CRC bits based at least in part on receiving the message that indicates the location of the PDCCH message.

Aspect 8: The method of any of Aspects 1-7, further comprising: receiving, from the network node, a message indicating an indication of a timing associated with activation of the quantity of CRC bits.

Aspect 9: The method of any of Aspects 1-8, wherein the PDCCH message is received in accordance with the quantity of the CRC bits based at least in part on a time duration elapsing after reception of the message that includes the location of the PDCCH message.

Aspect 10: The method of any of Aspects 1-9, further comprising: receiving, from the network node, an indication of a polynomial associated with generation of the CRC bits.

Aspect 11: The method of Aspect 10, wherein the generation of the CRC bits is performed in accordance with a partial usage of the polynomial, and wherein the polynomial is associated with CRC generation for blind-decoded PDCCH messages.

Aspect 12: The method of Aspect 10, wherein the polynomial is different from an additional polynomial associated with CRC generation for blind-decoded PDCCH messages.

Aspect 13: The method of Aspect 12, wherein the polynomial is selected from a plurality of polynomials in accordance with a quantity of decoding operations associated with the PDCCH message.

Aspect 14: The method of any of Aspects 1-13, wherein the quantity of the CRC bits is in accordance with a quantity of decoding operations associated with the PDCCH message.

Aspect 15: A method of wireless communication performed by a network node, comprising: transmitting, to a UE, a message that includes an indication of a location of a PDCCH message; and transmitting, to the UE, the PDCCH message in the location, wherein a quantity of CRC bits associated with the PDCCH message is in accordance with the indication of the location of the PDCCH message.

Aspect 16: The method of Aspect 15, wherein the quantity of the CRC bits is reduced by a first quantity of bits from an additional quantity of CRC bits configured for blind-decoded PDCCH messages.

Aspect 17: The method of Aspect 16, wherein a first quantity of payload bits associated with the PDCCH message is increased by the first quantity of bits from a second quantity of payload bits configured for the blind-decoded PDCCH messages.

Aspect 18: The method of Aspect 16, wherein a first quantity of payload bits associated with the PDCCH message is the same as a second quantity of payload bits configured for the blind-decoded PDCCH messages, and wherein a first code rate associated with the PDCCH message is reduced from a second rate associated with the blind-decoded PDCCH messages in accordance with the first quantity of payload bits and the quantity of the CRC bits.

Aspect 19: The method of Aspect 16, wherein a first coded word size associated with the PDCCH message is reduced by the first quantity of bits from a second coded word size configured for the blind-decoded PDCCH messages, and wherein a first spectral efficiency associated with the PDCCH message is increased from a second spectral efficiency associated with the blind-decoded PDCCH messages in accordance with the first coded word size and the quantity of the CRC bits.

Aspect 20: The method of any of Aspects 15-19, further comprising: transmitting, to the UE, an indication of the quantity of the CRC bits associated with the PDCCH message.

Aspect 21: The method of Aspect 20, wherein the quantity of the CRC bits is selected in accordance with receiving the indication of the location of the PDCCH message.

Aspect 22: The method of any of Aspects 15-21, further comprising: transmitting, to the UE, a message indicating an indication of a timing associated with activation of the quantity of CRC bits.

Aspect 23: The method of Aspect 22, wherein the PDCCH message is received in accordance with the quantity of the CRC bits based at least in part on a time duration elapsing after reception of the message that includes the location of the PDCCH message.

Aspect 24: The method of any of Aspects 15-23, further comprising: transmitting, to the UE, an indication of a polynomial associated with generation of the CRC bits.

Aspect 25: The method of Aspect 24, wherein the generation of the CRC bits is performed in accordance with a partial usage of the polynomial, and wherein the polynomial is associated with CRC generation for blind-decoded PDCCH messages.

Aspect 26: The method of Aspect 24, wherein the polynomial is different from an additional polynomial associated with CRC generation for blind-decoded PDCCH messages.

Aspect 27: The method of Aspect 26, wherein the polynomial is selected from a plurality of polynomials in accordance with a quantity of decoding operations associated with the PDCCH message.

Aspect 28: The method of any of Aspects 15-27, wherein the quantity of the CRC bits is in accordance with a quantity of decoding operations associated with the PDCCH message.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.

Aspect 30: An apparatus for wireless communication at a device, the apparatus comprising one or more memories and one or more processors coupled to the one or more memories, the one or more processors configured to cause the device to perform the method of one or more of Aspects 1-28.

Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

Aspect 34: A device for wireless communication, the device comprising a processing system that includes one or more processors and one or more memories coupled with the one or more processors, the processing system configured to cause the device to perform the method of one or more of Aspects 1-28.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

Aspect 36: A device comprising a processing system that includes one or more processors and one or more code-storing memories coupled with the one or more processors, the processing system configured to cause the device to perform the method of one or more of Aspects 1-28.

Aspect 37: A device comprising a processing system that includes processor circuitry and code-storing memory circuitry, the processing system configured to cause the device to perform the method of one or more of Aspects 1-28.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For instance, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, For instance, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (For instance, if used in conjunction with “either” or “only one of”). For instance, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (For instance, an element “having” A also may have B).

As used herein, the phrase “associated with” is intended to be interpreted in the inclusive sense, unless otherwise explicitly indicated. For instance, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a message that includes an indication of a location of a physical downlink control channel (PDCCH) message; and
receive, from the network node, the PDCCH message in the location, wherein a quantity of cyclic redundancy check (CRC) bits associated with the PDCCH message is in accordance with the indication of the location of the PDCCH message.

2. The UE of claim 1, wherein the quantity of the CRC bits is reduced by a first quantity of bits from an additional quantity of CRC bits configured for blind-decoded PDCCH messages.

3. The UE of claim 2, wherein a first quantity of payload bits associated with the PDCCH message is increased by the first quantity of bits from a second quantity of payload bits configured for the blind-decoded PDCCH messages.

4. The UE of claim 2, wherein a first quantity of payload bits associated with the PDCCH message is the same as a second quantity of payload bits configured for the blind-decoded PDCCH messages, and wherein a first code rate associated with the PDCCH message is reduced from a second rate associated with the blind-decoded PDCCH messages in accordance with the first quantity of payload bits and the quantity of the CRC bits.

5. The UE of claim 2, wherein a first coded word size associated with the PDCCH message is reduced by the first quantity of bits from a second coded word size configured for the blind-decoded PDCCH messages, and wherein a first spectral efficiency associated with the PDCCH message is increased from a second spectral efficiency associated with the blind-decoded PDCCH messages in accordance with the first coded word size and the quantity of the CRC bits.

6. The UE of claim 1, wherein the processing system is configured to cause the UE to:
receive, from the network node, an indication of the quantity of the CRC bits associated with the PDCCH message.

7. The UE of claim 1, wherein the PDCCH message is received in accordance with the quantity of the CRC bits based at least in part on receiving the message that indicates the location of the PDCCH message.

8. The UE of claim 1, wherein the processing system is configured to cause the UE to:
receive, from the network node, a message indicating an indication of a timing associated with activation of the quantity of CRC bits.

9. The UE of claim 1, wherein the PDCCH message is received in accordance with the quantity of the CRC bits based at least in part on a time duration elapsing after reception of the message that includes the location of the PDCCH message.

10. The UE of claim 1, wherein the processing system is configured to cause the UE to:
receive, from the network node, an indication of a polynomial associated with generation of the CRC bits.

11. The UE of claim 10, wherein the generation of the CRC bits is performed in accordance with a partial usage of the polynomial, and wherein the polynomial is associated with CRC generation for blind-decoded PDCCH messages.

12. The UE of claim 10, wherein the polynomial is different from an additional polynomial associated with CRC generation for blind-decoded PDCCH messages.

13. The UE of claim 12, wherein the polynomial is selected from a plurality of polynomials in accordance with a quantity of decoding operations associated with the PDCCH message.

14. The UE of claim 1, wherein the quantity of the CRC bits is in accordance with a quantity of decoding operations associated with the PDCCH message.

15. A method of wireless communication performed by a user equipment (UE), comprising:
receiving, from a network node, a message that includes an indication of a location of a physical downlink control channel (PDCCH) message; and
receiving, from the network node, the PDCCH message in the location, wherein a quantity of cyclic redundancy check (CRC) bits associated with the PDCCH message is in accordance with the indication of the location of the PDCCH message.

16. The method of claim 15, wherein the quantity of the CRC bits is reduced by a first quantity of bits from an additional quantity of CRC bits configured for blind-decoded PDCCH messages.

17. The method of claim 16, wherein a first quantity of payload bits associated with the PDCCH message is increased by the first quantity of bits from a second quantity of payload bits configured for the blind-decoded PDCCH messages.

18. The method of claim 16, wherein a first quantity of payload bits associated with the PDCCH message is the same as a second quantity of payload bits configured for the blind-decoded PDCCH messages, and wherein a first code rate associated with the PDCCH message is reduced from a second rate associated with the blind-decoded PDCCH messages in accordance with the first quantity of payload bits and the quantity of the CRC bits.

19. The method of claim 16, wherein a first coded word size associated with the PDCCH message is reduced by the first quantity of bits from a second coded word size configured for the blind-decoded PDCCH messages, and wherein a first spectral efficiency associated with the PDCCH message is increased from a second spectral efficiency associated with the blind-decoded PDCCH messages in accordance with the first coded word size and the quantity of the CRC bits.

20. A non-transitory computer-readable medium storing a set of instructions for wireless communication, the set of instructions comprising:
one or more instructions that, when executed by one or more processors of a user equipment (UE), cause the UE to:
receive, from a network node, a message that includes an indication of a location of a physical downlink control channel (PDCCH) message; and
receive, from the network node, the PDCCH message in the location, wherein a quantity of cyclic redundancy check (CRC) bits associated with the PDCCH message is in accordance with the indication of the location of the PDCCH message.
